(19) United States
(12) Patent Application Publication
(10) Pub. No.: US 2025/0176038 A1
(43) Pub. Date: May 29, 2025

(54) SIDELINK LOGICAL CHANNEL PRIORITIZATION BASED ON A CHANNEL ACCESS PRIORITY CLASS

(71) Applicant: Lenovo (Singapore) Pte. Ltd., New Tech Park (SG)

(72) Inventors: Joachim Löhr, Wiesbaden (DE); Karthikeyan Ganesan, Kronberg im Taunus (DE); Alexander Golitschek Edler von Elbwart, Darmstadt (DE); Ravi Kuchibhotla, Chicago, IL (US)

(21) Appl. No.: 18/841,204

(22) PCT Filed: Feb. 23, 2023
(86) PCT No.: PCT/IB2023/051685

§ 371 Date: Aug. 23, 2024

Related U.S. Application Data
(60) Provisional application No. 63/314,112, filed on Feb. 25, 2022.

(51) Int. Cl. H04W 74/08; H04W 74/00

(52) U.S. Cl. CPC H04W 74/0875; H04W 74/006

(57) ABSTRACT

Apparatuses, methods, and systems are disclosed for sidelink (“SL”) logical channel prioritization (“LCP”) based on a channel access priority class (“CAPC”). One method includes receiving, at a user equipment, downlink control information (“DCI”) allocating sidelink resources. The DCI includes a CAPC field indicating a CAPC value. The method includes performing a sidelink logical channel prioritization procedure based on the CAPC value for generation of a sidelink transport block according to the sidelink resources. The method includes performing a listen-before-talk (“LBT”) procedure for transmission of a sidelink transport block on the sidelink resources.

### FIELD

The subject matter disclosed herein relates generally to wireless communications and more particularly relates to sidelink (“SL”) logical channel prioritization (“LCP”) based on a channel access priority class (“CAPC”).

### BACKGROUND

In certain wireless communications networks, a CAPC may be used. In such networks, a network device may not be aware of the CAPC used.

### BRIEF SUMMARY

Methods for SL LCP based on a CAPC are disclosed. Apparatuses and systems also perform the functions of the methods. One embodiment of a method includes receiving, at a user equipment, downlink control information (“DCI”) allocating sidelink resources. The DCI includes a CAPC field indicating a CAPC value. In some embodiments, the method includes performing a SL LCP procedure based on the CAPC value for generation of a sidelink transport block according to the sidelink resources. In certain embodiments, the method includes performing a listen-before-talk (“LBT”) procedure for transmission of a sidelink transport block on the sidelink resources.

One apparatus for SL LCP based on a CAPC includes a user equipment (“UE”). In some embodiments, the apparatus includes a receiver that receives DCI allocating sidelink resources. The DCI includes a CAPC field indicating a CAPC value. In various embodiments, the apparatus includes a processor that: performs a SL LCP procedure based on the CAPC value for generation of a sidelink transport block according to the sidelink resources; and performs a LBT procedure for transmission of a sidelink transport block on the sidelink resources.

Another embodiment of a method for SL LCP based on a CAPC includes transmitting, from a network device, DCI allocating sidelink resources. The DCI includes a CAPC field indicating a CAPC value, and a SL LCP procedure is performed based on the CAPC value for generation of a sidelink transport block according to the sidelink resources.

Another apparatus for SL LCP based on a CAPC includes a network device. In some embodiments, the apparatus includes a transmitter that transmits DCI allocating sidelink resources. The DCI includes a CAPC field indicating a CAPC value, and a SL LCP procedure is performed based on the CAPC value for generation of a sidelink transport block according to the sidelink resources.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1 is a schematic block diagram illustrating one embodiment of a wireless communication system for SL LCP based on a CAPC;

FIG. 2 is a schematic block diagram illustrating one embodiment of an apparatus that may be used for SL LCP based on a CAPC;

FIG. 3 is a schematic block diagram illustrating one embodiment of an apparatus that may be used for SL LCP based on a CAPC;

FIG. 4 is a schematic block diagram illustrating one embodiment of a medium access control (“MAC”) protocol data unit (“PDU”);

FIG. 5 is a flow chart diagram illustrating one embodiment of a method for SL LCP based on a CAPC; and

FIG. 6 is a flow chart diagram illustrating another embodiment of a method for SL LCP based on a CAPC.

### DETAILED DESCRIPTION

As will be appreciated by one skilled in the art, aspects of the embodiments may be embodied as a system, apparatus, method, or program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a program product embodied in one or more computer readable storage devices storing machine readable code, computer readable code, and/or program code, referred hereafter as code. The storage devices may be tangible, non-transitory, and/or non-transmission. The storage devices may not embody signals. In a certain embodiment, the storage devices only employ signals for accessing code.

Certain of the functional units described in this specification may be labeled as modules, in order to more particularly emphasize their implementation independence. For example, a module may be implemented as a hardware circuit comprising custom very-large-scale integration (“VLSI”) circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in code and/or software for execution by various types of processors. An identified module of code may, for instance, include one or more physical or logical blocks of executable code which may, for instance, be organized as an object, procedure, or function. Nevertheless, the executables of an identified module need not be physically located together, but may include disparate instructions stored in different locations which, when joined logically together, include the module and achieve the stated purpose for the module.

Indeed, a module of code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different computer readable storage devices. Where a module or portions of a module are implemented in software, the software portions are stored on one or more computer readable storage devices.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random access memory (“RAM”), a read-only memory (“ROM”), an erasable programmable read-only memory (“EPROM” or Flash memory), a portable compact disc read-only memory (“CD-ROM”), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Code for carrying out operations for embodiments may be any number of lines and may be written in any combination of one or more programming languages including an object oriented programming language such as Python, Ruby, Java, Smalltalk, C++, or the like, and conventional procedural programming languages, such as the “C” programming language, or the like, and/or machine languages such as assembly languages. The code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (“LAN”) or a wide area network (“WAN”), or the connection may be made to an external computer (for example, through the Internet using an Internet Service Provider).

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to,” unless expressly specified otherwise. An enumerated listing of items does not imply that any or all of the items are mutually exclusive, unless expressly specified otherwise. The terms “a,” “an,” and “the” also refer to “one or more” unless expressly specified otherwise.

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Aspects of the embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. The code may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams block or blocks.

The code may also be stored in a storage device that can direct a computer, other programmable data processing apparatus, or other devices to function in a particular manner, such that the instructions stored in the storage device produce an article of manufacture including instructions which implement the function/act specified in the schematic flowchart diagrams and/or schematic block diagrams block or blocks.

The code may also be loaded onto a computer, other programmable data processing apparatus, or other devices to cause a series of operational steps to be performed on the computer, other programmable apparatus or other devices to produce a computer implemented process such that the code which execute on the computer or other programmable apparatus provide processes for implementing the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods and program products according to various embodiments. In this regard, each block in the schematic flowchart diagrams and/or schematic block diagrams may represent a module, segment, or portion of code, which includes one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each figure may refer to elements of proceeding figures. Like numbers refer to like elements in all figures, including alternate embodiments of like elements.

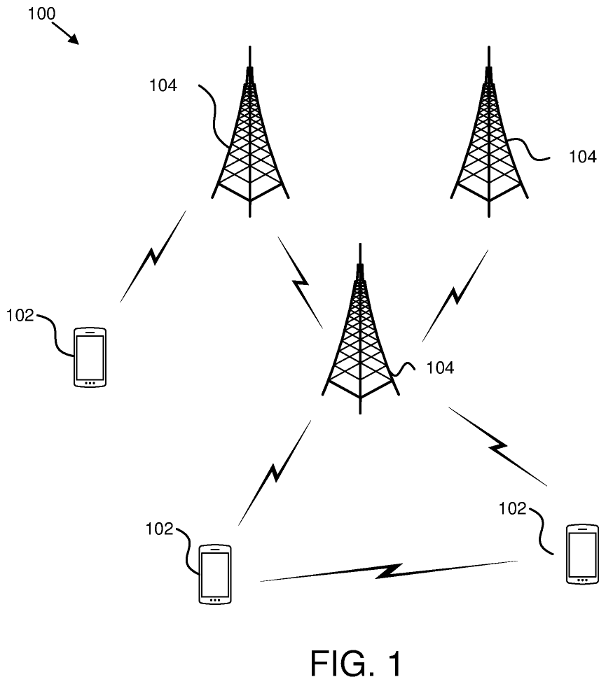

FIG. 1 depicts an embodiment of a wireless communication system 100 for SL LCP based on a CAPC. In one embodiment, the wireless communication system 100 includes remote units 102 and network units 104. Even though a specific number of remote units 102 and network units 104 are depicted in FIG. 1, one of skill in the art will recognize that any number of remote units 102 and network units 104 may be included in the wireless communication system 100.

In one embodiment, the remote units 102 may include computing devices, such as desktop computers, laptop computers, personal digital assistants (“PDAs”), tablet computers, smart phones, smart televisions (e.g., televisions connected to the Internet), set-top boxes, game consoles, security systems (including security cameras), vehicle on-board computers, network devices (e.g., routers, switches, modems), aerial vehicles, drones, or the like. In some embodiments, the remote units 102 include wearable devices, such as smart watches, fitness bands, optical head-mounted displays, or the like. Moreover, the remote units 102 may be referred to as subscriber units, mobiles, mobile stations, users, terminals, mobile terminals, fixed terminals, subscriber stations, UE, user terminals, a device, or by other terminology used in the art. The remote units 102 may communicate directly with one or more of the network units 104 via uplink (“UL”) communication signals. In certain embodiments, the remote units 102 may communicate directly with other remote units 102 via sidelink communication.

The network units 104 may be distributed over a geographic region. In certain embodiments, a network unit 104 may also be referred to and/or may include one or more of an access point, an access terminal, a base, a base station, a location server, a core network (“CN”), a radio network entity, a Node-B, an evolved node-B (“eNB”), a 5G node-B (“gNB”), a Home Node-B, a relay node, a device, a core network, an aerial server, a radio access node, an access point (“AP”), new radio (“NR”), a network entity, an access and mobility management function (“AMF”), a unified data management (“UDM”), a unified data repository (“UDR”), a UDM/UDR, a policy control function (“PCF”), a radio access network (“RAN”), a network slice selection function (“NSSF”), an operations, administration, and management (“OAM”), a session management function (“SMF”), a user plane function (“UPF”), an application function, an authentication server function (“AUSF”), security anchor functionality (“SEAF”), trusted non-third generation partnership project (“3GPP”) gateway function (“TNGF”), or by any other terminology used in the art. The network units 104 are generally part of a radio access network that includes one or more controllers communicably coupled to one or more corresponding network units 104. The radio access network is generally communicably coupled to one or more core networks, which may be coupled to other networks, like the Internet and public switched telephone networks, among other networks. These and other elements of radio access and core networks are not illustrated but are well known generally by those having ordinary skill in the art.

In one implementation, the wireless communication system 100 is compliant with NR protocols standardized in 3GPP, wherein the network unit 104 transmits using an orthogonal frequency division multiplexing (“OFDM”) modulation scheme on the downlink (“DL”) and the remote units 102 transmit on the UL using a single-carrier frequency division multiple access (“SC-FDMA”) scheme or an OFDM scheme. The remote units 102 may also communicate with one another using a sidelink interface. More generally, however, the wireless communication system 100 may implement some other open or proprietary communication protocol, for example, WiMAX, institute of electrical and electronics engineers (“IEEE”) 802.11 variants, global system for mobile 5 communications (“GSM”), general packet radio service (“GPRS”), universal mobile telecommunications system (“UMTS”), long term evolution (“LTE”) variants, code division multiple access 2000 (“CDMA2000”), Bluetooth®, ZigBee, Sigfoxx, among other protocols. The present disclosure is not intended to be limited to the implementation of any particular wireless communication system architecture or protocol.

The network units 104 may serve a number of remote units 102 within a serving area, for example, a cell or a cell sector via a wireless communication link. The network units 104 transmit DL communication signals to serve the remote units 102 in the time, frequency, and/or spatial domain.

In various embodiments, a remote unit 102 may receive, at a UE, DCI allocating sidelink resources. The DCI includes a CAPC field indicating a CAPC value. In some embodiments, the remote unit 102 may perform a SL LCP procedure based on the CAPC value for generation of a sidelink transport block according to the sidelink resources. In certain embodiments, the remote unit 102 may perform a LBT procedure for transmission of a sidelink transport block on the sidelink resources. Accordingly, the remote unit 102 may be used for SL LCP based on a CAPC.

In certain embodiments, a network unit 104 may transmit, from a network device, DCI allocating sidelink resources. The DCI includes a CAPC field indicating a CAPC value, and a SL LCP procedure is performed based on the CAPC value for generation of a sidelink transport block according to the sidelink resources. Accordingly, the network unit 104 may be used for SL LCP based on a CAPC.

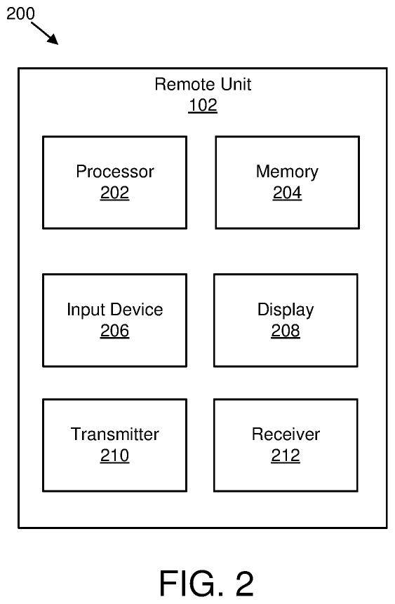

FIG. 2 depicts one embodiment of an apparatus 200 that may be used for SL LCP based on a CAPC. The apparatus 200 includes one embodiment of the remote unit 102. Furthermore, the remote unit 102 may include a processor 202, a memory 204, an input device 206, a display 208, a transmitter 210, and a receiver 212. In some embodiments, the input device 206 and the display 208 are combined into a single device, such as a touchscreen. In certain embodiments, the remote unit 102 may not include any input device 206 and/or display 208. In various embodiments, the remote unit 102 may include one or more of the processor 202, the memory 204, the transmitter 210, and the receiver 212, and may not include the input device 206 and/or the display 208.

The processor 202, in one embodiment, may include any known controller capable of executing computer-readable instructions and/or capable of performing logical operations. For example, the processor 202 may be a microcontroller, a microprocessor, a central processing unit (“CPU”), a graphics processing unit (“GPU”), an auxiliary processing unit, a field programmable gate array (“FPGA”), or similar programmable controller. In some embodiments, the processor 202 executes instructions stored in the memory 204 to perform the methods and routines described herein. The processor 202 is communicatively coupled to the memory 204, the input device 206, the display 208, the transmitter 210, and the receiver 212.

The memory 204, in one embodiment, is a computer readable storage medium. In some embodiments, the memory 204 includes volatile computer storage media. For example, the memory 204 may include a RAM, including dynamic RAM (“DRAM”), synchronous dynamic RAM (“SDRAM”), and/or static RAM (“SRAM”). In some embodiments, the memory 204 includes non-volatile computer storage media. For example, the memory 204 may include a hard disk drive, a flash memory, or any other suitable non-volatile computer storage device. In some embodiments, the memory 204 includes both volatile and non-volatile computer storage media. In some embodiments, the memory 204 also stores program code and related data, such as an operating system or other controller algorithms operating on the remote unit 102.

The input device 206, in one embodiment, may include any known computer input device including a touch panel, a button, a keyboard, a stylus, a microphone, or the like. In some embodiments, the input device 206 may be integrated with the display 208, for example, as a touchscreen or similar touch-sensitive display. In some embodiments, the input device 206 includes a touchscreen such that text may be input using a virtual keyboard displayed on the touchscreen and/or by handwriting on the touchscreen. In some embodiments, the input device 206 includes two or more different devices, such as a keyboard and a touch panel.

The display 208, in one embodiment, may include any known electronically controllable display or display device. The display 208 may be designed to output visual, audible, and/or haptic signals. In some embodiments, the display 208 includes an electronic display capable of outputting visual data to a user. For example, the display 208 may include, but is not limited to, a liquid crystal display (“LCD”), a light emitting diode (“LED”) display, an organic light emitting diode (“OLED”) display, a projector, or similar display device capable of outputting images, text, or the like to a user. As another, non-limiting, example, the display 208 may include a wearable display such as a smart watch, smart glasses, a heads-up display, or the like. Further, the display 208 may be a component of a smart phone, a personal digital assistant, a television, a table computer, a notebook (laptop) computer, a personal computer, a vehicle dashboard, or the like.

In certain embodiments, the display 208 includes one or more speakers for producing sound. For example, the display 208 may produce an audible alert or notification (e.g., a beep or chime). In some embodiments, the display 208 includes one or more haptic devices for producing vibrations, motion, or other haptic feedback. In some embodiments, all or portions of the display 208 may be integrated with the input device 206. For example, the input device 206 and display 208 may form a touchscreen or similar touch-sensitive display. In other embodiments, the display 208 may be located near the input device 206.

In certain embodiments, the receiver 212 receives DCI allocating sidelink resources. The DCI includes a CAPC field indicating a CAPC value. In various embodiments, the processor 202: performs a SL LCP procedure based on the CAPC value for generation of a sidelink transport block according to the sidelink resources; and performs a LBT procedure for transmission of a sidelink transport block on the sidelink resources.

Although only one transmitter 210 and one receiver 212 are illustrated, the remote unit 102 may have any suitable number of transmitters 210 and receivers 212. The transmitter 210 and the receiver 212 may be any suitable type of transmitters and receivers. In one embodiment, the transmitter 210 and the receiver 212 may be part of a transceiver.

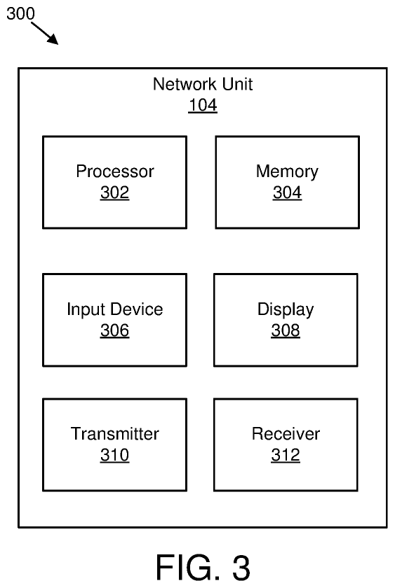

FIG. 3 depicts one embodiment of an apparatus 300 that may be used for SL LCP based on a CAPC. The apparatus 300 includes one embodiment of the network unit 104. Furthermore, the network unit 104 may include a processor 302, a memory 304, an input device 306, a display 308, a transmitter 310, and a receiver 312. As may be appreciated, the processor 302, the memory 304, the input device 306, the display 308, the transmitter 310, and the receiver 312 may be substantially similar to the processor 202, the memory 204, the input device 206, the display 208, the transmitter 210, and the receiver 212 of the remote unit 102, respectively.

In certain embodiments, the transmitter 310 transmits DCI allocating sidelink resources. The DCI includes a CAPC field indicating a CAPC value, and a SL LCP procedure is performed based on the CAPC value for generation of a sidelink transport block according to the sidelink resources.

It should be noted that one or more embodiments herein may be combined together. In certain embodiments, such as in new radio (“NR”) unlicensed (“U”) (“NR-U”), channel access in both downlink and uplink rely on listen-before-talk (“LBT”). In such embodiments, a gNB and/or a UE must first sense the channel to find out there is no on-going communications prior to any transmission. When a communication channel is a wide bandwidth unlicensed carrier, a clear channel assessment (“CCA”) procedure relies on detecting an energy level on multiple sub-bands of a communications channel. In some embodiments, no beamforming is considered for LBT in NR-U and only omni-directional LBT is used.

In various embodiments, such as for NR-U, LBT failure handling includes: 1) a MAC relying on reception of a notification of UL LBT failure from a physical layer to detect a consistent UL LBT failure; 2) a UE switching to another bandwidth part (“BWP”) and initiating a random access channel (“RACH”) upon declaration of consistent LBT failure on a primary cell (“PCell”) or a primary serving cell (“PSCell”) if there is another BWP with configured RACH resources; 3) the UE shall perform radio link failure (“RLF”) recovery if a consistent UL LBT failure is detected on the PCell and UL LBT failure is detected on “N” possible BWP; 4) if consistent uplink LBT failures are detected on the PSCell, the UE informs a mobile network (“MN”) via a secondary cell group (“SCG”) failure information procedure after detecting a consistent UL LBT failure on “N” BWPs; 5) “N” is the number of configured BWPs with configured physical RACH (“PRACH”) resources-if N is larger than one it is up to UE implementation to determine which BWP the UE selects; and/or 6) if consistent uplink LBT failures are detected on an SCell, a new MAC control element (“CE”) to report this to the node where SCell belongs to is used.

In certain embodiments, a consistent LBT failure UE is allowed to autonomously switch an UL BWP. Other UL BWPs of an NR-U cell may not be subject to large number of LBT failures (e.g., different LBT sub-bands are used for different UL BWPs).

In some embodiments, such as for LTE enhanced licensed assisted access (“eLAA”), autonomous uplink (“AUL”) transmissions are enabled through a combination of radio resource control (“RRC”) signaling and an activation message conveyed by downlink control information (“DCI”) in a physical control channel. The RRC configuration includes subframes in which the UE is allowed to transmit autonomously, as well as eligible hybrid automatic repeat request (“HARQ”) process identifiers (“IDs”). The activation message includes the resource block assignment (“RBA”) and modulation and coding scheme (“MCS”), from which the UE is able to determine the transport block size for any AUL transmission.

In various embodiments, it is possible to autonomously retransmit data pertaining to a transport block (“TB”) that has not been received correctly by an eNB. For this purpose, the UE monitors downlink feedback information (“DFI”) (e.g., AUL DFI (“AUL-DFI”)), which can be transmitted by the eNB and includes HARQ acknowledgment (“ACK”) (“HARQ-ACK”) information for the AUL-enabled HARQ process IDs. If the UE detects a non-acknowledgment (“NACK”) message, it may try to autonomously access the channel for a retransmission of the same transport block in the corresponding HARQ process. As a safe-guard against errors, an autonomous uplink transmission includes at least the HARQ process ID and a new data indicator (“NDI”) accompanying a physical uplink shared channel (“PUSCH”) (e.g., AUL uplink control information (“UCI”) (“AUL-UCI”).

In certain embodiments, it is possible for the eNB to transmit an uplink grant through a DCI that assigns uplink resources for a retransmission of the same transport block using an indicated HARQ process. It is further possible that the eNB transmits an uplink grant through a DCI that assigns uplink resources for transmission of a new transport block using the indicated HARQ process. In other words, even though a HARQ process ID can be eligible for AUL transmissions, the eNB still has access to this process at any time through a scheduling grant (e.g., DCI). In general, if the UE detects a grant for an UL transmission for a subframe that is eligible for AUL (e.g., according to an RRC configuration), it will follow the received grant and will not perform an AUL transmission in that subframe. Table 1 illustrates one embodiment of fields for AUL-UCI.

TABLE 1
Fields for AUL-UCI

| | Bit width | |
|---|---|---|
| | 1 transport | 2 transport |
| Field | block | blocks |
| AUL cell (“C”) radio network | 16 | 16 |
| temporary identifier (“RNTI”) | | |
| (“C-RNTI”) | | |
| HARQ process number | 4 | 4 |
| Redundancy version | 2 | 2 |
| New data indicator | 1 | 2 |
| PUSCH starting symbol | 1 | 1 |
| PUSCH ending symbol | 1 | 1 |
| Channel occupancy time | 1 | 1 |
| (“COT”) sharing indication | | |

In some embodiments, COT sharing is shown by: 1) sharing of a UE-initiated channel occupancy (e.g., either configured grant (“CG”) PUSCH (“CG-PUSCH”) or scheduled UL) with gNB supported, such that the gNB is allowed to transmit control signals, broadcast signals, control channels, and/or broadcast channels for any UEs as long as the transmission contains transmissions for the UE that initiated the channel occupancy and/or downlink (“DL”) signals and/or channels (e.g., physical downlink shared channel (“PDSCH”), physical downlink control channel (“PDCCH”), reference signals) meant for the UE that initiated the channel occupancy; 2) a threshold (e.g., energy detection (“ED”) threshold) that the UE applies if initiating a channel occupancy to be shared with the gNB if configured by the gNB (e.g., RRC signaling), a) if the threshold that the UE applies if initiating a channel occupancy to be shared with the gNB is not configured, the transmission of the gNB in UE initiated COT may include only control and/or broadcast signals and/or channels transmissions of up to 2, 4, and/or 8 orthogonal frequency division multiplexing (“OFDM”) symbols in duration for 15, 30, and/or 60 kHz subcarrier spacing (“SCS”), and b) if absence of wireless fidelity (“WiFi”) cannot be assumed based on a regulation, the threshold that the gNB configures to the UE to apply if initiating the channel occupancy is determined based on a maximum gNB transmit (“TX”) power; 3) category 2 LBT is used (e.g., for gaps of 16 us and 25 us); 4) category 1 LBT is used under the following conditions: a) gap duration <=16 us, b) for the transmission of the gNB after the first switch between the UE and the gNB if the gNB transmission contains only control and/or broadcast signals and/or channels, and c) for the transmission of the gNB after the first switch between the UE and the gNB if the gNB transmission has a duration below X ms (e.g., X>=0).

In various embodiments, for a category 2 LBT in a 16 us gap, energy measurement is done for a total of at least 5 us with at least 4 us of sensing falling within the 9 us slot immediately before the transmission. LBT is said to be successful if the measured energy is lower than a threshold.

In certain embodiments, NR-U LBT procedures for channel access may be summarized as follows: 1) both gNB-initiated and UE-initiated COTs use category 4 LBT where the start of a new transmission burst always performs LBT with exponential backoff-only with the exception that if the demodulation reference signal (“DRS”) is to be at most one ms in duration and is not multiplexed with unicast PDSCH; and/or 2) UL transmission within a gNB initiated COT or a subsequent DL transmission within a UE or gNB initiated COT transmits immediately without sensing only if the gap from the end of the previous transmission is not more than 16 μs, otherwise category 2 LBT must be used and the gap cannot exceed 25 μs.

In some embodiments, UE and/or gNB in unlicensed carriers has to perform an LBT operation, and within category 4 LBT, several CAPCs are defined to have differentiated channel access parameters as shown in Table 2.

TABLE 2

| CAPC | | | | | allowed CWₚ |
|---|---|---|---|---|---|
| (p) | mₚ | CW_{min,p} | CW_{max,p} | T_{mcot,p} | sizes |
| 1 | 1 | 3 | 7 | 2 ms | {3, 7} |
| 2 | 1 | 7 | 15 | 3 ms | {7, 15} |
| 3 | 3 | 15 | 63 | 8 or 10 ms | {15, 31, 63} |
| 4 | 7 | 15 | 1023 | 8 or 10 ms | {15, 31, 63, 127, |
| | | | | | 255, 511, 1023} |

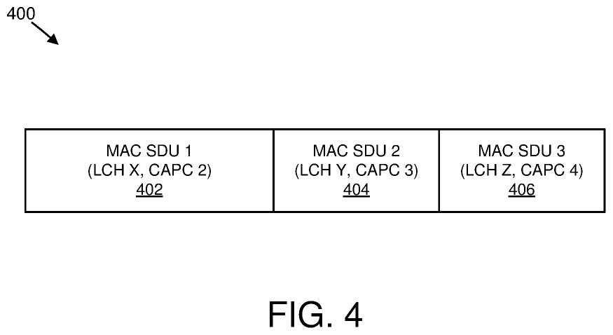

In various embodiments, for dynamically scheduled uplink resources (e.g., UL DCI), a gNB indicates a CAPC to be used by a UE for a corresponding uplink transmission. For an uplink configured grant, a network cannot signal the CAPC index for every occasion, and thus the UE itself has to select which CAPC is used for each occasion. In certain embodiments, for data radio bearers (“DRBs”), a UE selects a highest CAPC index (e.g., lowest priority) of logical channels (“LCHs”) multiplexed in a TB. In the FIG. 4, the UE will select the CAPC 4 from Table 2 (e.g., the lowest priority).

FIG. 4 is a schematic block diagram illustrating one embodiment of a MAC PDU 400. The MAC PDU 400 includes a MAC service data unit (“SDU”) 1 402 (e.g., LCH X, CAPC 2), a MAC SDU 2 404 (e.g., LCH Y, CAPC 3), and a MAC SDU 406 (e.g., LCH Z, CAPC 4).

In certain embodiments, a very small amount of data belongs to a highest CAPC index, but a UE still has to apply the highest CAPC index for high-priority data, which leads to some delay for the transmission. Therefore, for UL CG, if SRB (e.g., downlink control channel (“DCCH”)) SDU is included in MAC PDU, a UE selects the CAPC index of the SRB (e.g., DCCH). Otherwise, the UE selects the highest CAPC index (e.g., lowest priority) of LCHs multiplexed in MAC PDU.

In some embodiments, a CAPC of radio bearers and MAC CEs are either fixed or configurable as being: 1) fixed to a lowest priority for a padding buffer status report (“BSR”) and recommended bit rate MAC CEs; 2) fixed to a highest priority for SRB0, SRB1, SRB3, and other MAC CEs; and/or 3) configured by the gNB for SRB2 and DRB.

In various embodiments, if choosing a CAPC of a DRB, a gNB takes into account fifth generation (“5G”) quality of service (“QoS”) identifiers (“ID”) (“5Qis”) of all the QoS flows multiplexed in that DRB while considering fairness between different traffic types and transmissions. Table 3 shows which CAPC should be used for which standardized 5Qis (e.g., which CAPC to use for a given QoS flow). It should be noted that a QoS flow corresponding to a non-standardized 5QI (e.g., operator specific 5QI) should use the CAPC of the standardized 5QI which best matches the QoS characteristics of the non-standardized 5QI.

TABLE 3
Mapping between CAPC and 5QI

| CAPC | 5QI |
|---|---|
| 1 | 1, 3, 5, 65, 66, 67, 69, 70, 79, 80, 82, 83, 84, 85 |
| 2 | 2, 7, 71 |
| 3 | 4, 6, 8, 9, 72, 73, 74, 76 |
| 4 | — |

In Table 3, it should be noted that a lower CAPC value may mean a higher priority.

In certain embodiments, if performing category 4 LBT (“CAT4-LBT”) (e.g., Type 1 LBT) for the transmission of an uplink TB and if the CAPC is not indicated in DCI, the UE selects the CAPC as follows: 1) if only MAC CEs are included in the TB, the highest priority CAPC of those MAC CEs is used; 2) if common control channel (“CCCH”) SDUs are included in the TB, the highest priority CAPC is used; 3) if dedicated control channel (“DCCH”) SDUs are included in the TB, the highest priority CAPC of the DCCHs is used; and/or 4) the lowest priority CAPC of the logical channels with MAC SDU multiplexed in the TB is used otherwise.

In some embodiments, such as in NR-U, a CAPC value used if performing a LBT procedure of the transmission of a TB is either selected by a gNB (e.g., for dynamically scheduled PUSCH transmissions), or selected by the UE autonomously (e.g., for CG PUSCH transmissions). In such embodiments, it is not clear how the CAPC value is selected for SL transmissions if operating in a shared spectrum channel access. For example, for mode 1, if the UE selects the CAPC value autonomously, the gNB is not aware of the length of the COT acquired by the TX UE (e.g., maximum COT (“MCOT”), which might lead to a situation where SL resource allocations fall outside the UE acquired COT. To allow the gNB to make efficient scheduling decisions, the gNB should be aware of the maximum length of an acquired COT by the UE.

In various embodiments, an efficient scheduling of sidelink transmission may be allowed by a gNB considering a CAPC value used by a UE if performing an LBT procedure for a sidelink transmission.

In a first embodiment, a MAC entity of a UE is configured with zero, one, or more scheduling request (“SR”) configurations for a network to UE (“Uu”) interface to request SL resources from a gNB. According to one aspect of the first embodiment, a SR configuration implicitly indicates a CAPC value used by the UE if performing an LBT procedure for an SL shared channel (“SCH”) (“SL-SCH”) transmission (allocated). A SR configuration includes a set of physical uplink control channel (“PUCCH”) resources for a SR across different BWPs and cells. According to one implementation of the first embodiment, each of the one or more SR configurations is associated with a CAPC value. In another implementation, each SR configuration is associated with a range of CAPC values. To enable efficient scheduling of sidelink transmissions by having a closer match of sidelink channel access parameters (e.g., including a CAPC value) used by the UE for the LBT procedure performed for a SL-SCH transmission, an early indication to a gNB of a channel access parameter (e.g., CAPC) through the use of a SR configuration is used. Such an indication allows for making sensible scheduling decisions for SL transmission at the gNB (e.g., mode 1). In certain embodiments, providing a channel access parameter (e.g., CAPC) to the gNB makes the gNB aware of a maximum length of an acquired COT by a UE. It should be noted that an MCOT depends on the CAPC selected and/or determined by the UE for an LBT.

In some embodiments, a SR configuration is associated with a number of SL resource allocations UE requests from a gNB. In one example, an SR configuration implicitly indicates to the gNB how many SL resource allocations UE requests from the gNB. The UE may determine the indicated number of requested SL resource allocations based on its buffer occupancy and/or status and the assumed MCOT determined based on a selected CAPC. For example, the SR may indicate whether a TX UE requests 2, 4, or 6 SL resource allocations based on the amount of data in its transmit buffer as well as the CAPC value to be used for an LBT (e.g., as given by the buffer status).

In various embodiments, a UE provides information on a selected CAPC value to be used for an LBT procedure within a SL BSR, e.g., a new indication and/or field in the SL BSR MAC CE. Similarly, the SL BSR may in one example, indicate a number of requested SL resource allocations (e.g., number of SL resources within a COT).

In a second embodiment, a UE receives a SL DCI on a Uu interface from a gNB allocating one or more SL resources (e.g., physical sidelink control channel (“PSCCH”) and/or physical sidelink shared channel (“PSSCH”) resources) in response to having sent a SR and/or sidelink buffer status report (“SL BSR”) on the Uu interface requesting SL resources. Such SL resources may be in consecutive slots (e.g., back-to-back), or also in non-consecutive slots (e.g., gaps between different SL resource allocations). According to one implementation of the second embodiment, the UE performs a SL LCP procedure in response to the reception of the SL DCI.

In one implementation of the second embodiment, the UE selects the destination and performs logical channel multiplexing and/or TB generation based on logical channel restrictions configured by a network (“NW”) and LCH priorities. The UE sets the CAPC for the LBT procedure as indicated in the SR and/or SL BSR to the gNB when requesting SL resources. According to another implementation of the second embodiment, the UE sets the CAPC value to be used when performing LBT for the generated TB regardless of the content of the generated TB (e.g., TB according to the allocated first SL resource allocation within the SL DCI). In the first embodiment, the SR and/or SL BSR implicitly indicates the CAPC value which the UE is using for the corresponding LBT (e.g., LBT for allocated SL resources).

According to one aspect of the second embodiment, the UE uses the CAPC value as indicated via the SR and/or SL BSR only for performing LBT for the first SL resource allocation of the one or more SL resource allocations within the SL DCI. For subsequent SL resource allocations (e.g., LBT for the remaining SL resource allocations allocated within the SL DCI, if any), the UE selects the CAPC autonomously according to some predefined rules.

According to another alternative implementation of the second embodiment, the UE multiplexes, during an LCP procedure for the first of the one or more SL resource allocations received within the SL DCI, only SL LCHs with an associated CAPC index which is greater than or equal to the indicated CAPC index implicitly indicated via the SR and/or SL BSR. A new sidelink logical channel multiplexing restriction may be applied according to this alternative implementation of the second embodiment. This is to ensure that the selected CAPC for the generated TB matches the CAPC index and/or value indicated via the SR and/or BSR.

According to one aspect of the second embodiment, the SL DCI allocating multiple SL resources indicates, if the SL resources are not in subsequent slots (e.g., SL resources are not allocated in consecutive time slots), the LBT type UE shall apply if performing LBT for the transmission of a SL TB according to the allocated SL resources.

In a third embodiment, a UE performs at least part of an LCP procedure and selects a CAPC value and/or index before requesting SL resources from a gNB by transmitting a SR and/or SL BSR. According to one implementation of the third embodiment, a SL UE (e.g., TX UE) selects a CAPC value and/or index based on the result of a (e.g., at least part of) LCP procedure considering the current UE's buffer status for cases if a SL SR and/or BSR is triggered. The SR implicitly indicates to the gNB the CAPC value and/or index that the UE is applying if performing an LBT procedure for a SL transmission (e.g., for which the UE requests SL resources from the gNB). Therefore, the TX UE has to perform at least part of a SL LCP procedure and determine a CAPC value and/or index (e.g., as a result of the LCP procedure) before sending a SL SR and/or BSR to the gNB. According to a further aspect of the third embodiment, the UE performs, upon reception of a SL grant from the gNB (e.g., as a response to the signaled SL SR and/or BSR), a further LCP procedure where only SL LCHs with an associated CAPC index which is higher than or equal to the indicated CAPC index implicitly indicated via the SR and/or BSR are considered.

In various embodiments, a CAPC value is either selected by the gNB (e.g., for dynamically scheduled PUSCH transmissions), or selected by the UE autonomously (e.g., for CG PUSCH transmissions). In certain embodiments, it is not clear how a CAPC value is selected for SL transmissions if operating in shared spectrum channel access considering that SL resource allocation can be done by the gNB (e.g., mode 1) or by the TX UE autonomously (e.g., mode 2). For example, for mode 1, if the UE selects the CAPC value autonomously, the gNB is not aware of the length of the COT acquired by the TX UE (e.g., MCOT), which might lead to a situation where SL resource allocations falls outside the UE acquired COT. To allow the gNB to make efficient scheduling decisions, the gNB should be aware of the maximum length of an acquired COT by UE.

In certain embodiments, there may be methods to allow for an efficient CAPC handling for sidelink transmission on a cell configured with a shared spectrum.

In a fourth embodiment, SL DCI allocating SL resources to a UE indicates a CAPC index and/or value within the DCI which is to be used if performing an LBT for the transmission of the TB generated according to the allocated SL resources. According to one implementation of the fourth embodiment, the SL DCI contains a new field which indicates the CAPC index and/or value associated with the SL resources allocated within the SL DCI. According to a further aspect of the fourth embodiment, the TX UE multiplexes, in response to receiving a SL DCI indicating a CAPC index and/or value, only SL LCHs with an associated CAPC index that is greater than or equal to the indicated CAPC index within the SL DCI. If receiving a SL DCI for a PSCCH and/or PSSCH transmission on an unlicensed cell wherein the SL DCI is indicating a CAPC (e.g., CAPC), a UE is only allowed to multiplex data of SL LCHs or MAC CEs in the MAC PDU that have the same or a higher CAPC (e.g., lower CAPC value) than the signaled CAPC value in the DCI. For example, if the SL DCI indicates CAPC=1, the UE will only multiplex data that has a CAPC equal to one (e.g., the highest CAPC). The UE is not allowed to multiplex data of SL LCHs or MAC CEs which have a lower CAPC (e.g., CAPC=3). According to the fourth embodiment, a SL LCP procedure only considers SL LCHs and/or MAC CEs for TB generation satisfying the CAPC condition (e.g., CAPC if configured) that is is less than or equal to the CAPC value signaled within the SL grant.

According to another implementation of the fourth embodiment, the UE performs the SL LCP procedure upon receiving a SL DCI indicating a CAPC value and/or index without considering the CAPC value associated with a SL LCH and uses the indicated CAPC value when performing LBT for the SL transmission on the scheduled SL resources. In this implementation, the SL LCP procedure doesn't apply a further LCH restriction related to the CAPC value of a LCH (e.g., a legacy LCP procedure is applied).

In a fifth embodiment, a UE autonomously selects a CAPC to be used when performing category 4 LBT (e.g., Type 1 LBT) for the transmission of a sidelink TB according to predefined rules. In the fifth embodiment, a gNB has no control over the CAPC used by a sidelink TX UE even for the mode 1 resource allocation mode. In one example, the predefined rules may include a logical AND combination or a logical OR combination of: 1) if performing LBT for the transmission of a sidelink TB, the UE selects the CAPC as: a) if only SL MAC CEs are included in the SL TB, the highest priority CAPC of those SL MAC CEs is used; b) if only SL MAC CEs are included in the SL TB, the highest priority CAPC is used; c) if sidelink broadcast control channel (“SBCCH”) SDUs are included in the TB, the highest priority CAPC is used; d) if sidelink control channel (“SCCH”) SDUs are included in the TB, the highest priority CAPC is used; e) if SCCH SDUs are included in the TB, the highest priority CAPC of the SCCHs is used; f) the lowest priority CAPC of the SL logical channels (e.g., sidelink traffic channel (“STCH”)) with MAC SDU multiplexed in the TB is used otherwise; or g) the highest priority CAPC of the SL logical channels (e.g., STCH) with MAC SDU multiplexed in the TB is used otherwise. It should be noted that the SBCCH is a channel for broadcasting SL system information from a UE to other UEs. A sidelink control channel (“SCCH”) is a channel for transmission of control information (e.g., SL RRC (“PC5-RRC”) and PC5-S messages) from a UE to other UEs. STCH refers to a logical channel for transmission of user information from a UE to other UEs.

In a sixth embodiment, a CAPC index and/or value is configured for a resource pool. According to one implementation of the sixth embodiment, a UE uses the CAPC value and/or index configured for a resource pool if performing LBT for the transmission of a sidelink TB within this resource pool. When selecting the transmission resource pool in mode 2, the UE considers the CAPC value and/or index associated with the resource pool, e.g., UE may only transmit a SL TB in a resource pool if the SL LCHs which are multiplexed in the TB are having an associated CAPC value which is matching or being greater than the CAPC value configured for the resource pool.

In a seventh embodiment, a UE increases a CAPC (e.g., adopts a lower CAPC value) for the next transmission attempt of the same SL TB if the previous transmission attempt was not successful (e.g., if the SL TB couldn't be transmitted on PSSCH due to a LBT failure). In one implementation of the seventh embodiment, the UE increases the CAPC (e.g., lowers the corresponding value) for a next transmission attempt for LBT failure if the SL TB contains high priority data such as SCCH SDUs or MAC CEs. If, for example, a CAPC of value 3 was used for a transmission attempt, then the UE may use the CAPC of value 2 for the next transmission attempt of the same TB. According to another implementation of the seventh embodiment, the UE may increase the CAPC of a TB for a hybrid automatic repeat request (“HARQ”) retransmission. If the initial transmission of a TB was done with a CAPC value 3, then the UE may, in one example, use a CAPC value 2 for the HARQ retransmission if the initial transmission or an earlier retransmission wasn't successfully decoded.

In an eighth embodiment, sidelink control information (“SCI”) indicates a CAPC value and/or index. According to one implementation of the eighth embodiment, a TX UE signals the CAPC value and/or index used for the LBT of the corresponding PSCCH and/or PSSCH transmission within the SCI information to a receive (“RX”) UE. In another implementation of the eighth embodiment, the CAPC value and/or index is signaled within the 2nd stage SCI. The signaled CAPC value may be used by the RX UE to optimize its discontinuous reception (“DRX”) operation. According to a further embodiment of the eighth embodiments, the SCI signals the MCOT acquired by the Tx UE.

In certain embodiments, such as in NR-U, a CAPC value is either selected by the gNB (e.g., for dynamically scheduled PUSCH transmissions), or selected by the UE autonomously (e.g., for CG PUSCH transmissions). It may not be clear how the CAPC value is selected for SL transmissions if operating in a shared spectrum channel access. For example, for mode 1, if the UE selects the CAPC value autonomously, the gNB is not aware of the length of the COT acquired by the TX UE (e.g., MCOT), which might lead to a situation where a SL resource allocations fall outside the UE acquired COT. To allow the gNB to make efficient scheduling decisions, the gNB should be aware of the maximum length of an acquired COT by the UE.

In some embodiments, for a multi-slot SL grant, where a single DCI schedules multiple SL resource allocation, some efficient CAPC handling is used in various embodiments. Furthermore, for a multi-slot SL grant the UE may not be able to transmit high priority SL data or MAC CE due to an LBT failure occurring for the first of the multiple SL allocations, so that the corresponding TB would not be decodable without further (e.g., later) retransmissions. Since the UE performs LBT to initiate a sequence of SL transmissions within the multi-slot SL grant, the first SL grant is the most probable instance where SL transmission failure may occur due to CCA failure.

In a nineth embodiment, a single SL DCI schedules multiple NR PSCCH and NR PSSCH in one cell. The SL DCI format indicates multiple SL resource allocations to a SL UE. According to one implementation of the nineth embodiment, the new SL DCI format schedules multiple SL resource allocations by means of a bitmap, where each field of the bitmap corresponds to a SL slot. If a field of the bitmap is set to ‘0’, it means that there is no SL resource allocation in the corresponding SL slot. A field in the bitmap set to ‘1’ indicates that a SL resource is allocated for the corresponding SL slot. A further field in the DCI indicates the starting SL slot of the bitmap (e.g., time gap between SL DCI to first SL slot of the bitmap is signaled within the SL DCI). In another implementation of the nineth embodiment, the multiple SL resources have the same size and same frequency resource allocation (e.g., same starting resource block (“RB”) and same number of RBs). According to a further implementation of the nineth embodiment, the SL DCI allocates multiple SL resources in consecutive slots, whereas a time gap indicator within the DCI indicates where the UE shall transmit the first SL transmission (e.g., PSCCH and/or PSSCH). Each Sidelink resource allocation has a separate starting symbol (e.g., within the slot) and length of allocated symbols. In one example, the SL DCI indicates a HARQ process ID field which indicates the HARQ process ID of the first SL allocation. For the subsequent SL resource allocations, the HARQ process ID value is incremented by one for each SL allocation.

According to another implementation of the nineth embodiment, the TX UE may use the multiple SL allocations for initial transmission as well as HARQ retransmissions. It is up to the TX UE to decide whether to use it for an initial transmission or a retransmission.

According to one implementation of the nineth embodiment, the single SL DCI scheduling multiple SL transmissions signals a CAPC index and/or value. The signaled CAPC index and/or value will be used by the UE for the first of the one or more SL transmissions. In one example, the UE will select the CAPC indices and/or values for the remaining SL transmissions autonomously. Alternatively, in another implementation of the nineth embodiment, the UE indicates the CAPC index and/or value for all scheduled SL transmissions.

According to a further implementation of the nineth embodiment, the signaled CAPC index and/or value will be used by the UE for the first of the one or more SL transmissions. In one example, the UE will select the CAPC indices and/or values for the remaining SL transmissions autonomously if LBT is successful for the first SL transmission. Otherwise, the UE will use the indicated CAPC value if performing LBT for the subsequent (e.g., second) SL transmission.

According to one aspect of the nineth embodiment, the SL DCI allocating multiple SL resources indicates if the SL resources are not in subsequent slots (e.g., SL resources are not allocated in consecutive time slots), the LBT type UE will apply if performing LBT for the transmission of a SL TB according to the allocated SL resources

According to a tenth embodiment, a UE performs a destination selection during an LCP procedure only for the first of multiple SL transmissions allocated by a single SL DCI. In one implementation of the tenth embodiment, the UE uses the same destination as determined for the first SL transmission for the subsequent SL transmissions of the multi-SL transmission grant. If there is no more data available for transmission for the selected destination, the UE performs destination selection and transmits data to a different destination on the remaining allocated SL resources.

According to an eleventh embodiment, a UE performs an LBT procedure for the transmission of a SL TB of the TB contains data for a destination which is different compared to the last made SL transmission. According to one implementation of the eleventh embodiment, a TX UE needs to perform an LBT procedure for a SL transmission regardless of whether the gap between the last made SL transmission by the TX UE is shorter than a predefined threshold if the SL transmission is made to a different destination (e.g., SL transmission to a different RX UE). The motivation for performing the LBT procedure for a SL transmission if the transmission is to a different RX UE is that different Rx UEs may be at different locations; hence, the channel and/or LBT situation may be significantly different among different RX UEs the TX UE is in communication with. In particular, if a directional and/or spatial LBT is performed (e.g., for the NR operation in higher frequency bands up to 71 GHz and in contrast to an omni-directional LBT), it is beneficial to perform LBT for a SL transmission if the SL transmission is made to a different pair of source and destination layer 2 IDs (e.g., different RX UEs).

According to a twelfth embodiment, a UE may transmit a SL TB pending for transmission in a HARQ process due to a failed LBT in a different HARQ process being associated with a SL resource allocation for which LBT was successful. For a multi-SL transmission grant, the first SL allocation has the highest probability of LBT failure. Therefore, the UE may transmit the TB generated for the first SL allocation, which contains the high priority data in the UE's buffer including potential MAC CEs in the first SL allocation of the multiple SL allocations scheduled by the multi-SL grant for which LBT is successful. According to one implementation of the twelfth embodiment, the UE processes the SL grants scheduled within the multi-SL grant in the signaled order and generates the corresponding TBs according to an LCP procedure. However, to not delay the transmission of higher priority packets which may not be always acceptable, the UE may map the generated TBs internally to different HARQ processes for LBT failures. Given the assumption that the SL allocations and/or TB size is the same for all or at least several SL grants scheduled by a multi-SL grant, the dynamic mapping of TBs to HARQ processes should not impose any technical problems. According to the twelfth embodiment, autonomous retransmissions of a pending SL TB due to LBT failure is supported for different HARQ processes as long as the TB sizes match (e.g., autonomous retransmission can be performed on a different HARQ process). The functionality as described in the twelfth embodiment may be only supported if the SL TB contains some high priority data (e.g., highest priority contained in the SL TB is exceeded by a predefined threshold).

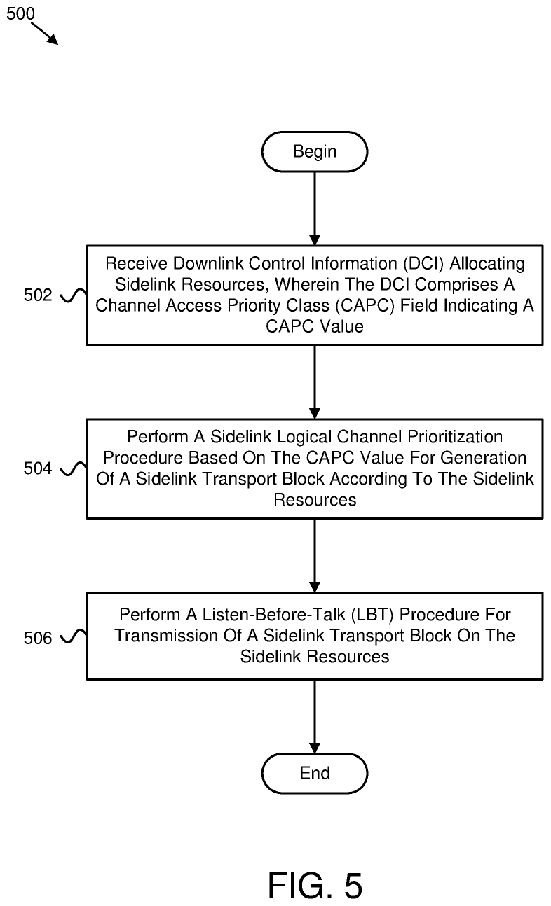

FIG. 5 is a flow chart diagram illustrating one embodiment of a method 500 for SL LCP based on a CAPC. In some embodiments, the method 500 is performed by an apparatus, such as the remote unit 102. In certain embodiments, the method 500 may be performed by a processor executing program code, for example, a microcontroller, a microprocessor, a CPU, a GPU, an auxiliary processing unit, a FPGA, or the like.

In various embodiments, the method 500 includes receiving 502, at a UE, DCI allocating sidelink resources. The DCI includes a CAPC field indicating a CAPC value. In some embodiments, the method 500 includes performing 504 a SL LCP procedure based on the CAPC value for generation of a sidelink transport block according to the sidelink resources. In certain embodiments, the method 500 includes performing 506 a LBT procedure for transmission of a sidelink transport block on the sidelink resources.

In certain embodiments, performing the LBT procedure further comprises using the CAPC value for selection of a channel access parameter. In some embodiments, the method 500 further comprises considering sidelink (SL) logical channels having an associated CAPC value greater than or equal to the CAPC value signaled within the DCI for the SL LCP procedure. In various embodiments, the method 500 further comprises not considering SL logical channels having an associated CAPC value less than the CAPC value signaled within the DCI for the SL LCP procedure.

In one embodiment, the CAPC value is configured for a resource pool. In certain embodiments, a transport block (TB) for transmission corresponds to the resource pool. In some embodiments, the method 500 further comprises transmitting the TB in response to the LBT procedure being successful.

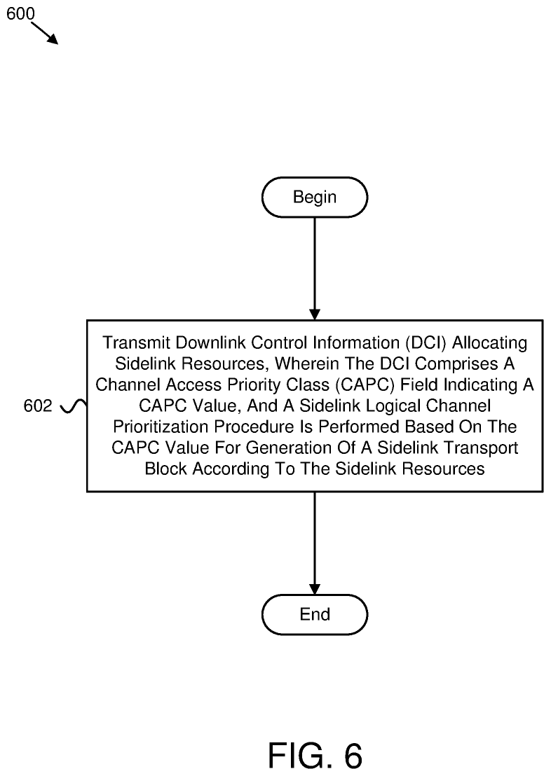

FIG. 6 is a flow chart diagram illustrating another embodiment of a method 600 for SL LCP based on a CAPC. In some embodiments, the method 600 is performed by an apparatus, such as the network unit 104. In certain embodiments, the method 600 may be performed by a processor executing program code, for example, a microcontroller, a microprocessor, a CPU, a GPU, an auxiliary processing unit, a FPGA, or the like.

In various embodiments, the method 600 includes transmitting 602, from a network device, DCI allocating sidelink resources. The DCI includes a CAPC field indicating a CAPC value, and a SL LCP procedure is performed based on the CAPC value for generation of a sidelink transport block according to the sidelink resources.

In certain embodiments, the CAPC value is configured for a resource pool.

In one embodiment, an apparatus comprises a UE. The apparatus further comprises: a receiver that receives DCI allocating sidelink resources, wherein the DCI comprises a CAPC field indicating a CAPC value; and a processor that: performs a SL LCP procedure based on the CAPC value for generation of a sidelink transport block according to the sidelink resources; and performs a LBT procedure for transmission of a sidelink transport block on the sidelink resources.

In certain embodiments, performing the LBT procedure further comprises using the CAPC value for selection of a channel access parameter.

In some embodiments, the processor considers sidelink (SL) logical channels having an associated CAPC value greater than or equal to the CAPC value signaled within the DCI for the SL LCP procedure.

In various embodiments, the processor does not consider SL logical channels having an associated CAPC value less than the CAPC value signaled within the DCI for the SL LCP procedure.

In one embodiment, the CAPC value is configured for a resource pool.

In certain embodiments, a transport block (TB) for transmission corresponds to the resource pool.

In some embodiments, the apparatus further comprising a transmitter that transmits the TB in response to the LBT procedure being successful.

In one embodiment, a method of a UE comprises: receiving DCI allocating sidelink resources, wherein the DCI comprises a CAPC field indicating a CAPC value; performing a SL LCP procedure based on the CAPC value for generation of a sidelink transport block according to the sidelink resources; and performing a LBT procedure for transmission of a sidelink transport block on the sidelink resources.

In certain embodiments, performing the LBT procedure further comprises using the CAPC value for selection of a channel access parameter.

In some embodiments, the method further comprises considering sidelink (SL) logical channels having an associated CAPC value greater than or equal to the CAPC value signaled within the DCI for the SL LCP procedure.

In various embodiments, the method further comprises not considering SL logical channels having an associated CAPC value less than the CAPC value signaled within the DCI for the SL LCP procedure.

In one embodiment, the CAPC value is configured for a resource pool.

In certain embodiments, a transport block (TB) for transmission corresponds to the resource pool.

In some embodiments, the method further comprises transmitting the TB in response to the LBT procedure being successful.

In one embodiment, an apparatus comprises a network device. The apparatus further comprises: a transmitter that transmits DCI allocating sidelink resources, wherein the DCI comprises a CAPC field indicating a CAPC value, and a SL LCP procedure is performed based on the CAPC value for generation of a sidelink transport block according to the sidelink resources.

In certain embodiments, the CAPC value is configured for a resource pool.

In one embodiment, a method of a network device comprises: transmitting DCI allocating sidelink resources, wherein the DCI comprises a CAPC field indicating a CAPC value, and a SL LCP procedure is performed based on the CAPC value for generation of a sidelink transport block according to the sidelink resources.

In certain embodiments, the CAPC value is configured for a resource pool.

Embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. A user equipment (UE), comprising:
at least one memory; and
at least one processor coupled with the at least one memory and configured to cause the UE to:
receive downlink control information (DCI) allocating sidelink resources, wherein the DCI comprises a channel access priority class (CAPC) field indicating a CAPC value;
perform a sidelink logical channel prioritization procedure based on the CAPC value for generation of a sidelink transport block according to the sidelink resources; and
perform a listen-before-talk (LBT) procedure for transmission of a sidelink transport block on the sidelink resources.

2. The UE of claim 1, wherein, to perform the LBT procedure, the at least one processor is configured to cause the UE to use the CAPC value for selection of a channel access parameter.

3. The UE of claim 1, wherein the at least one processor is configured to cause the UE to use sidelink (SL) logical channels having an associated CAPC value greater than or equal to the CAPC value signaled within the DCI for the sidelink logical channel prioritization procedure.

4. The UE of claim 1, wherein the at least one processor is configured to cause the UE to not use SL logical channels having an associated CAPC value less than the CAPC value signaled within the DCI for the sidelink logical channel prioritization procedure.

5. The UE of claim 1, wherein the CAPC value is configured for a resource pool.

6. The UE of claim 5, wherein the sidelink transport block for transmission corresponds to the resource pool.

7. The UE of claim 6, wherein the at least one processor is configured to cause the UE to transmit the sidelink transport block in response to the LBT procedure being successful.

8. A method performed by a user equipment (UE), the method comprising:
receiving downlink control information (DCI) allocating sidelink resources, wherein the DCI comprises a channel access priority class (CAPC) field indicating a CAPC value;
performing a sidelink logical channel prioritization procedure based on the CAPC value for generation of a sidelink transport block according to the sidelink resources; and
performing a listen-before-talk (LBT) procedure for transmission of a sidelink transport block on the sidelink resources.

9. The method of claim 8, wherein performing the LBT procedure further comprises using the CAPC value for selection of a channel access parameter.

10. The method of claim 8, further comprising using sidelink (SL) logical channels having an associated CAPC value greater than or equal to the CAPC value signaled within the DCI for the sidelink logical channel prioritization procedure.

11. The method of claim 8, further comprising not using SL logical channels having an associated CAPC value less than the CAPC value signaled within the DCI for the sidelink logical channel prioritization procedure.

12. The method of claim 8, wherein the CAPC value is configured for a resource pool.

13. The method of claim 12, wherein a transport block (TB) for transmission corresponds to the resource pool.

14. A base station, comprising:
at least one memory; and
at least one processor coupled with the at least one memory and configured to cause the base station to:
transmit downlink control information (DCI) allocating sidelink resources, wherein the DCI comprises a channel access priority class (CAPC) field indicating a CAPC value, wherein a sidelink logical channel prioritization procedure is performed based on the CAPC value for generation of a sidelink transport block according to the sidelink resources.

15. The base station of claim 14, wherein the CAPC value is configured for a resource pool.

16. A processor for wireless communication, comprising:
at least one controller coupled with at least one memory and configured to cause the processor to:
receive downlink control information (DCI) allocating sidelink resources, wherein the DCI comprises a channel access priority class (CAPC) field indicating a CAPC value;
perform a sidelink logical channel prioritization procedure based on the CAPC value for generation of a sidelink transport block according to the sidelink resources; and
perform a listen-before-talk (LBT) procedure for transmission of a sidelink transport block on the sidelink resources.

17. The processor of claim 16, wherein, to perform the LBT procedure, the at least one controller is configured to cause the processor to use the CAPC value for selection of a channel access parameter.

18. The processor of claim 16, wherein the at least one controller is configured to cause the processor to use sidelink (SL) logical channels having an associated CAPC value greater than or equal to the CAPC value signaled within the DCI for the sidelink logical channel prioritization procedure.

19. The processor of claim 16, wherein the at least one controller is configured to cause the processor to not use SL logical channels having an associated CAPC value less than the CAPC value signaled within the DCI for the sidelink logical channel prioritization procedure.

20. The processor of claim 16, wherein the CAPC value is configured for a resource pool.
